(19) United States
(12) Patent Application Publication
(10) Pub. No.: US 2010/0191725 A1
(43) Pub. Date: Jul. 29, 2010

(54) A SYSTEM AND METHOD FOR DISCOVERING PROVIDERS

(76) Inventor: Mehmet Kivanc Ozonat, Mountain View, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/358,447

(22) Filed: Jan. 23, 2009

(51) Int. Cl. G06F 17/30

(52) U.S. Cl. 707/726; 707/E17.108

(57) ABSTRACT

An exemplary embodiment of the present invention provides a method of identifying providers. The method comprises obtaining a keyword from a client and obtaining a results document from a search, wherein the results document comprises references to documents that contain the keyword. The method also comprises analyzing the results document to identify a plurality of the references, accessing the documents corresponding to the identified references, and analyzing the accessed documents to determine a list of keywords. The list of keywords is compared to lists of keywords associated with each of a plurality of category headings to identify a list of related category headings.

### BACKGROUND

The World-Wide Web (or Web) has numerous business directories, such as Yellowpages.com, which classify providers of goods and/or services by category headings such as telemarketers, printers, accountants, etc. A client using one of these directories can be asked to select a category heading and is presented with the list of providers under that category heading. However, the categorization may often be too coarse or too narrow. When it is too coarse, the client can be presented with a list of thousands of providers for the given category heading, which makes selecting a provider time consuming for the client and, thus, lowers the value of the directory. When the categorization is too narrow, the categorization loses accuracy since it is difficult to fit providers into one of the category headings. For example, many providers may span multiple category headings in a narrow categorization. Further, in a business directory with a narrow categorization, some category headings may end up with only one or two providers.

Other techniques can be used to locate providers on the Web. For example, search engines, such as Google.com and Yahoo.com, provide a ranking of their search results based on factors such as the number links pointing to the Web pages. Thus, search engines can be used as a proxy for finding providers. However, search engines provide very little or no guidance to clients in their search for providers. Often, the client may not be familiar with different terms, classifications and categorizations used in identifying providers. Thus, clients can find it difficult to identify search terms or keywords that will bring them the most accurate list of providers.

### BRIEF DESCRIPTION OF THE DRAWINGS

Certain exemplary embodiments are described in the following detailed description and in reference to the drawings, in which:

FIG. 1 is a block diagram of a computer network in which a client computer system can access a search engine for locating providers over a Web, in accordance with embodiments of the present invention;

FIG. 2 is a process flow diagram showing a method for locating providers in accordance with an exemplary embodiment of the present invention;

FIG. 3 is a process flow diagram showing a method 300 for building a keyword list for a guided search engine 104, in accordance with an exemplary embodiment of the present invention;

FIG. 4 is a block diagram showing a tangible, machine-readable medium that stores code adapted to locate providers, according to exemplary embodiments of the present invention;

FIG. 5 is an exemplary screen shot of an initial data entry screen for a search engine for locating providers, in accordance with an exemplary embodiment of the present invention;

FIG. 6 is an exemplary screen shot of a results page for a search engine for locating providers, in accordance with an exemplary embodiment of the present invention;

FIG. 7 is an exemplary screen shot of a results page for a search engine for locating providers, in accordance with an exemplary embodiment of the present invention; and

FIG. 8 is an exemplary screen shot of a results page for a search engine for locating providers, in accordance with an exemplary embodiment of the present invention.

### DETAILED DESCRIPTION OF SPECIFIC EMBODIMENTS

Exemplary embodiments of the present invention provide a guided search engine that can locate providers in a business directory by effectively linking category headings to predetermined keywords. The guided search engine can combine the classifications and categorization of providers in business directories with the advantages offered by generic search engines, such as relatively accurate and ranked list of search results brought in response to a given set of input search words.

In an exemplary embodiment of the present invention, the guided search engine works by obtaining a set of search words from a client. Examples of search terms that may be employed include “telemarketing services,” “print a brochure” or the like. From these keywords, the guided search engine provides a list of names and uniform resource locators (URL) for providers, as well as a list of related category headings. If the client is not satisfied with the providers presented, for example, if too many results are returned, the client can select one or more category headings from the list of related category headings. The guided search engine then refines the names and URLs for providers based on the selected category headings, and provides a new list of category headings. This process can be repeated until the client is satisfied with the results.

The search engine offers several advantages. The search engine provides a guided search for clients, who may not be fully familiar with the category headings, classes and terms used within the provider community. Further, it allows the client to select multiple category headings from the list of category headings. For example, if a list of category headings includes both “brochure design” and “brochure printing,” a client could select both entries to obtain combined search results. The search engine would then provide the names and URLs for only those providers that do both of these services, not just one of them.

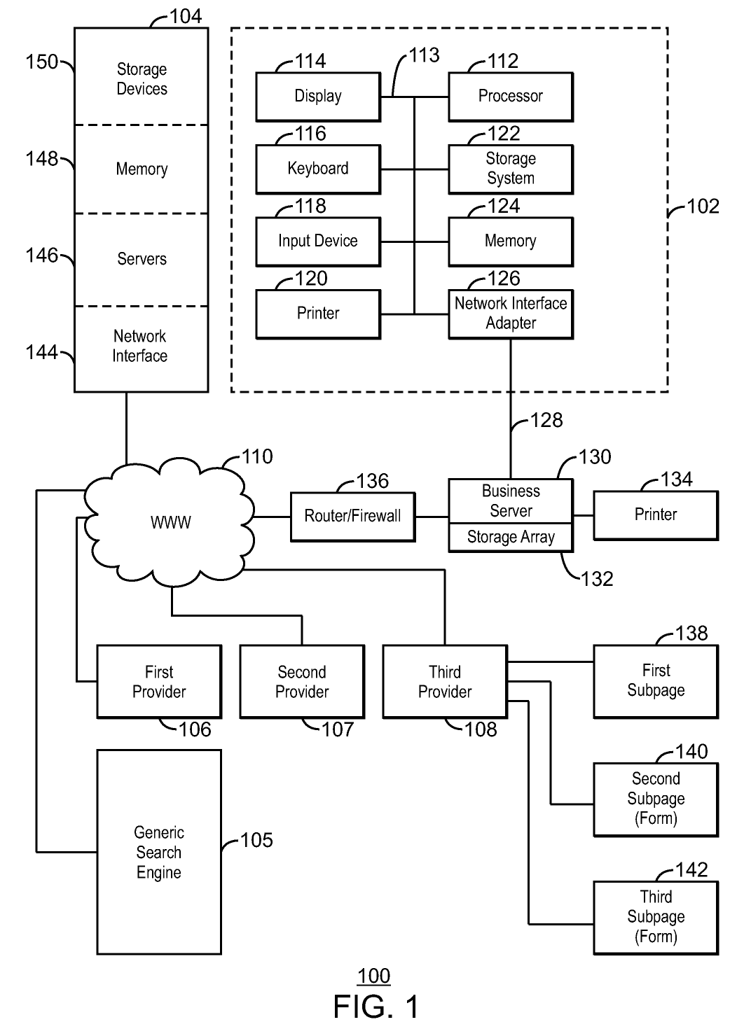

FIG. 1 is a block diagram of a computer network 100 in which a client system 102 can access a guided search engine 104, a generic search engine 105, and providers 106-108 over the Web 110, in accordance with embodiments of the present invention. As generally illustrated in FIG. 1, the client system 102 can have a processor 112 which is connected through a bus 113 to a display 114, and one or more input devices, such as a keyboard 116 and a pointing device 118. The client system 102 can also have an output device, such as a printer 120 connected to the bus 113.

The client system 102 can also have other units operatively coupled to the processor 112 through the bus 113. For example, the client system 102 can have tangible, machine-readable storage media, such as a storage system 122, for the long term storage of operating programs and data, for example, the programs and data used in embodiments of the present techniques. Further, the client system 102 can have one or more other types of tangible, machine-readable storage media, such as a memory 124, which may comprise read-only memory (ROM) and/or random access memory (RAM). In exemplary embodiments, the client system 102 can include a network interface adapter 126, for connecting the client system 102 to a network, for example, a local area network (LAN 128), a wide-area network (WAN), or another network configuration. The LAN 128 can include routers, switches, modems, or any other kind of interface device used for interconnection.

Through the LAN 128, the client system 102 can connect to a business server 130. The business server 130 can have a storage array 132 for storing enterprise data, buffering communications, and storing operating programs for the business server 130. The business server 132 can also have associated printers 134, scanners, copiers and the like. The business server 130 can access the Web 110 through a connected router/firewall 136, providing the client system 102 with Web access. The business network discussed above should not be considered limiting. Moreover, those of ordinary skill in the art will appreciate that business networks can be far more complex and can include numerous business servers 130, printers 134, routers 136, and client systems 102, among other units. In other embodiments, the client system 102 can be directly connected to the Web 110 through the network interface adapter 126, or can be connected through a router or firewall 136. Any system that allows the client system 102 to access the Web 110 should be considered to be within the scope of the present techniques.

The client system 102 can also access providers 106-108 through the Web 110. The providers 106-108 can have single Web pages, or as shown for the third provider 108, can have multiple subpages 138-142. The subpages 138-142 can provide information or links, such as the first subpage 138, or can include forms to be filled out by the user, as shown for the second and third subpages 140 and 142.

The guided search engine 104 can have numerous operational units to support exemplary embodiments of the present invention. For example, the guided search engine 104 can be operatively coupled to the Web 110 through a network interface 144, which can include routers, switches, network interface cards, and the like. Further, the guided search engine 104 can have servers 146 to operate the guided search engine 104. Through the network interface 144, the servers 146 can obtain data from the client system 102, access the generic search engine 105, and provide results to the client system 102. The servers 146 of the guided search engine 104 may access any number of types of tangible, machine-readable media. For example, the guided search engine can have associated memory 148, which can include RAM and/or ROM. The tangible, machine-readable memory can also include storage devices 150, such as hard drives, optical drives, and/or arrays of hard drives, among others. As will be apparent to one of ordinary skill in the art, the configuration of the guided search engine 104 is not limited to this description. The guided search engine 104 can be small, for example, including only a single server, or large, including multiple servers, depending on the expected traffic.

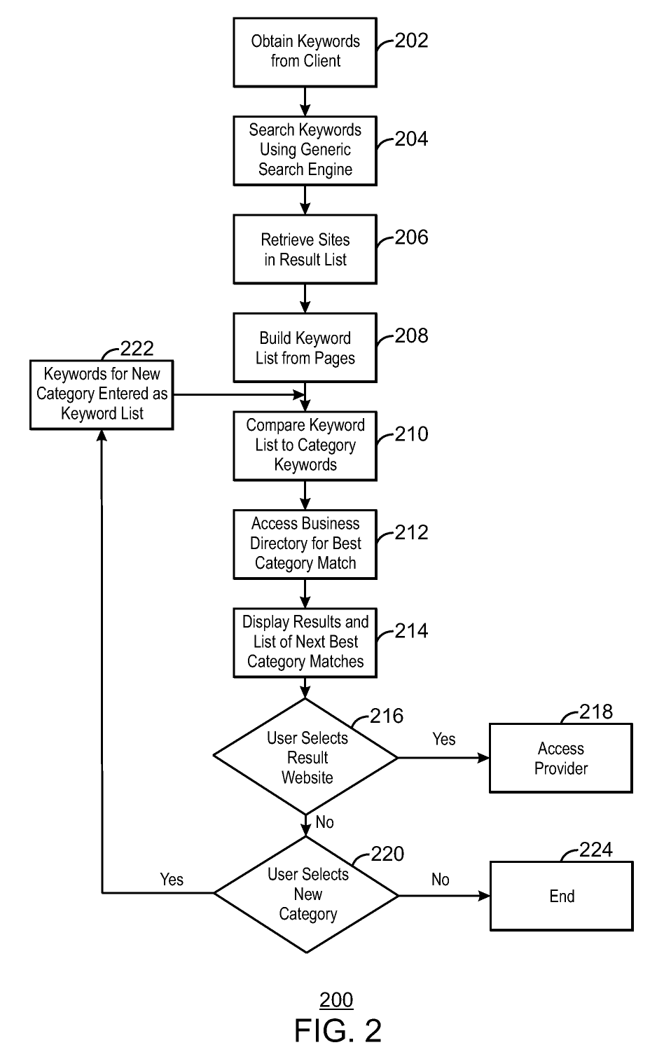

FIG. 2 is a process flow diagram showing a method 200 for identifying providers from search results in accordance with an exemplary embodiment of the present invention. Those of ordinary skill in the art will appreciate that some of the software components of the method 200 can be stored in and read from a tangible, machine-readable medium, such as the memory 148 or the storage device 150 of the guided search engine 104 shown in FIG. 1. In other embodiments, software components of the method 200 can operate in memory 124 associated with the client system 102, or in memory (not shown) associated with the business server 130.

In this exemplary embodiment, the method 200 begins the search in block 202, by obtaining keywords from a client through a Web browser. Web browsers that can be used with embodiments include such products as: Internet Explorer, available from Microsoft; Firefox, available from Mozilla; Chrome, available from Google; Safari, available from Apple; or any number of other Web browsers. The Web browsers can be implemented on any number of computing platforms, including the Macintosh operating system from Apple, the Windows operating system from Microsoft, or Linux based computing platforms, among others.

In block 204, the method 200 performs a search on the submitted keywords, for example, by submitting the keywords to a generic search engine 105, as shown in FIG. 1. In block 206, the source code for the results document returned from the search engine can be analyzed for links to other Web pages. The links can then be used to access the source code for each of the Web pages listed in the results document. For example, the links can be used in command strings, such as HTTP GET commands, or other command strings, to access each of the Web pages and obtain the source code of the Web page. The method 200 can be configured to access only a certain number of the Web pages listed in the results document, such as the first 10, the first 25, the first 100, or any other desired number.

The source code for each of the Web pages that are accessed from the results document can then be analyzed to build a keyword list, as indicated in block 208. Each keyword can be associated with a frequency or count, and the method 200 can be configured to ignore any words that fall below a certain count or frequency. Further, the method 200 can be configured to ignore words that can commonly be found in Web pages and may be irrelevant to the search, such as “the,” “a,” and “HTTP,” among others.

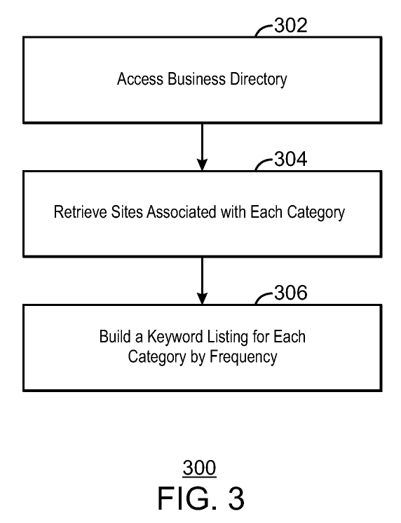

In block 210, the keywords obtained from the analysis of the Web pages from the results document can be compared to the content of the Web sites listed in a business directory, for example, by comparing the keyword list to previously generated lists of keywords associated with each category heading in the business directory. The keyword lists associated with the category headings can be generated, for example, by the method discussed with respect to FIG. 3. The comparison can result in a best match that indicates the category heading that may include Web sites most closely matching the client's requested terms. In block 212, the business directory can be accessed to obtain the list of Web sites that are associated with the category identified. A results page, for example, from the guided search engine, can be displayed, as shown in block 214. The results page can include a list of the Web sites from the business directory and a list of the next closest matching category headings, for example, arranged by the number of keywords that match.

At block 216, the client can select one of the provider Web sites, for example, from the results page of the guided search engine. If so, at block 218, the method 200 accesses the Web site for the provider and redirects the client to the provider's Web site. The client can terminate the search at that point, for example, if the provider's Web site contains the needed information, goods, or services. The client may also return to the results page from the Web site if further searching is desired, for example, by clicking on the “back” button in the browser. Further, the client may decide that none of the Web sites listed on the results page have the desired information. The client can then select one or more new category headings from the list presented on the results page of the guided search engine. If the client does not select a category heading, the method 200 stops the search, as shown at block 224, for example, when the client closes the browser window or moves to a new Web site.

If the client selects one or more new category headings to continue the search, the method 200 resumes at block 222, with the keywords from the new category headings entered as the keyword list. In an exemplary embodiment, the method 200 can use the previously determined keywords for the category headings selected as the new keyword list. In another embodiment, the method 200 can submit the selected category headings to the generic search engine and analyze the resulting Web pages to determine a new keyword list. The search then resumes at block 210, where the keyword list is compared to the keyword lists for the individual category headings in the business directory, prior to proceeding through the remaining steps.

FIG. 3 is a process flow diagram showing a method 300 for building a keyword list for a guided search engine 104, in accordance with an exemplary embodiment of the present invention. The method 300 begins at block 302 by accessing a business directory. The business directory can be created for the guided search engine, or a can be commercially available directory, such as Yellowpages.com or Thompson.net. The business directory can be combined with the guided search engine on a single server or may be separately accessed from the guided search engine, for example, over the Web.

The source code of each of the Web sites associated with each category heading within the business directory can be accessed, as indicated at block 304. In exemplary embodiments, the source code for each of the subpages within the domain of the Web sites can also be retrieved. However, in other embodiments, only the home page is used.

At block 306, a keyword list for each category heading is built by analyzing the frequency of words that appear in the source code of each of the Web pages under that category heading. The keywords can then be linked to the list of category headings for use by the guided search engine, as discussed with respect to FIG. 2. The method 300 can be adapted to ignore commonly found words that are not likely to relate to the search, such as “the,” “a,” “HTTP,” and others. Further, the method 300 can be configured to generate keyword lists that contain only the most frequent words appearing in the Web sites, such as words appearing more than a preselected number of times in the combined keyword list for all of the Web sites within a single category heading. For example, the keyword lists can contain words appearing more than about 1,000 times in the Web sites associated with a category heading, more than about 500 times, more than about 250 times, more than about 100 times, or with any other desired frequency. The present techniques are not limited to the illustrated method 300 for building a keyword list. Indeed, any number of other techniques, such as latent semantic indexing and/or singular value decomposition may be used in addition to or in place of the method 300.

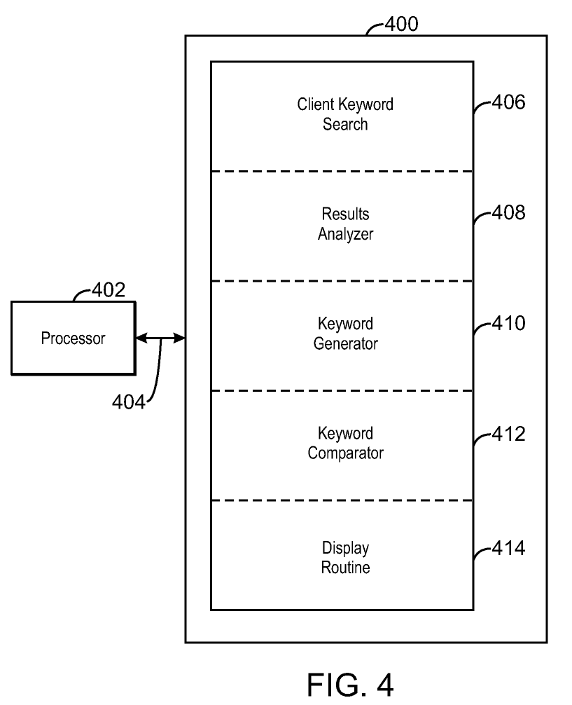

FIG. 4 is a block diagram showing a tangible, machine-readable medium that stores code adapted to facilitate the booting of a computer system in accordance with an exemplary embodiment of the present invention. The tangible, machine-readable medium is generally referred to by the reference number 400. The tangible, machine-readable medium 400 can comprise RAM, a hard disk drives, a non-volatile memory, a USB drive, a DVD, a CD or the like. In one exemplary embodiment of the present invention, the tangible, machine-readable medium 400 can be accessed by a processor 402 over a computer bus 404 within a server for a guided search engine.

The various software components discussed herein can be stored on the tangible, machine-readable medium 400 as indicated in FIG. 4. For example, a first block 406 on the tangible, machine-readable medium 400 may store a client keyword search routine to obtain a keyword from a client, search the keyword, and access a source code for the results document. A second block 408 can include a results analyzer for identifying and accessing documents linked to the results document returned from the keyword search. A third block 410 can include a keyword generator for analyzing the source code of the documents and generating a list of words in the documents, A fourth block 412 can include a keyword comparator for comparing keywords obtained from the search engine or the selected category headings with the list of keywords for the category heading. A fifth block 414 can include the display routine, which can be used to build a results page for the guided search page. Although shown as contiguous blocks, the software components can be stored in any order or configuration. For example, if the tangible, machine-readable medium 400 is a hard drive, the software components can be stored in non-contiguous, or even overlapping, sectors.

### EXAMPLE

A test was performed to determine the efficacy of the algorithm in locating appropriate category headings. In the test, Yellowpages.com was used as the business directory and Altavista.com was used as the generic search engine. In the test, the keyword “Marketing” was entered into the guided search engine, which resulted in the following list of category headings being returned from the guided search engine:
1. Direct Marketing Services;
2. Internet Marketing Advertising;
3. Marketing Consultants;
4. Marketing Programs Services; and
5. Product Design Development Marketing.

Selecting “Internet Marketing Advertising” from this list resulted in a new list of category headings being returned from the guided search engine:
1. Computer Network Design Systems;
2. Web Site Design Services;
3. Graphic Designers;
4. Internet Marketing Advertising;
5. Marketing Consultants;
6. Advertising Agencies;
7. Advertising Specialties; and
8. Web Site Hosting.

Selecting “Web Site Hosting” from this list resulted in the another list of category headings being returned from the guided search engine:
1. Computer Network Design Systems;
2. Web Site Design Services;
3. Internet Consultants;
4. Computer System Designers Consultants;
5. Computers Computer Equipment-Service Repair;
6. Internet Marketing Advertising;
7. Web Site Hosting; and
8. Internet Service Providers (ISP).

As a final example, selecting “Internet Service Providers” from this list resulted in the following list of category headings being returned from the guided search engine:
1. Computer Network Design Systems;
2. Web Site Design Services;
3. Internet Consultants;
4. Computer System Designers Consultants;
5. Computers Computer Equipment-Service Repair;
6. Internet Marketing Advertising;
7. Web Site Hosting; and
8. Internet Service Providers (ISP).
   As can be seen from these results, the category headings that were returned were closely related, but not identical, giving the client further information on appropriate category headings.

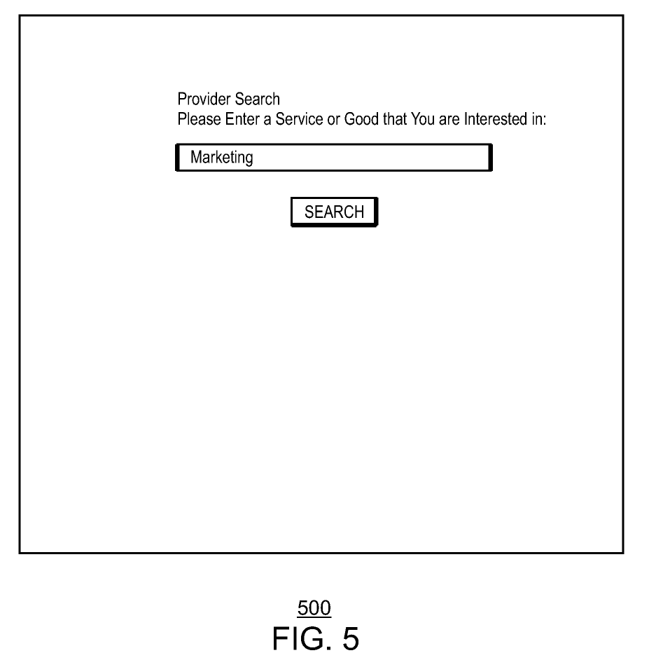

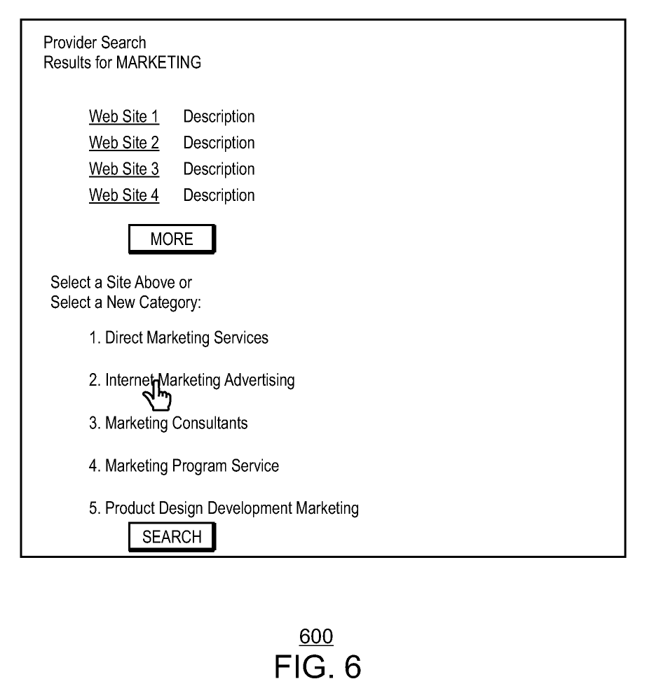

As a further example, in an exemplary embodiment of the present invention, the guided search engine could return a results page that includes both a list of potential providers and the list of category headings after each selection of a “search” button. For example, in an exemplary embodiment of the present invention, the search and results pages could appear as shown in FIGS. 5-8. In FIG. 5, a client could enter the search word, for example, “marketing,” and click on the “search” button. The guided search engine could then use the procedures discussed above to identify the most closely matched Web sites and to return a results page as shown in FIG. 6. The results page could include a listing of Web sites within that category heading on the business directory, e.g., “marketing.” The listing could show only a few sites or can have many sites listed over multiple pages. The client could click on one of the links and be redirected to a provider Web site, or may click on one or more of the category headings shown at the bottom of the page.

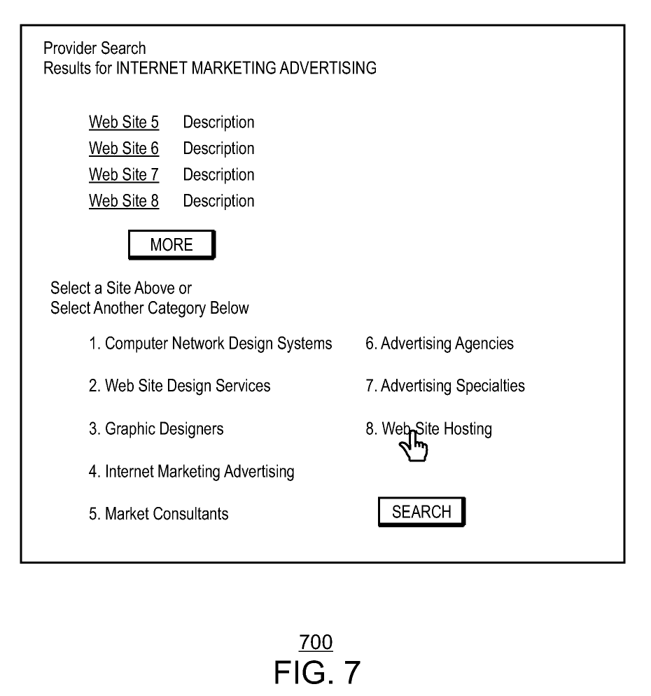

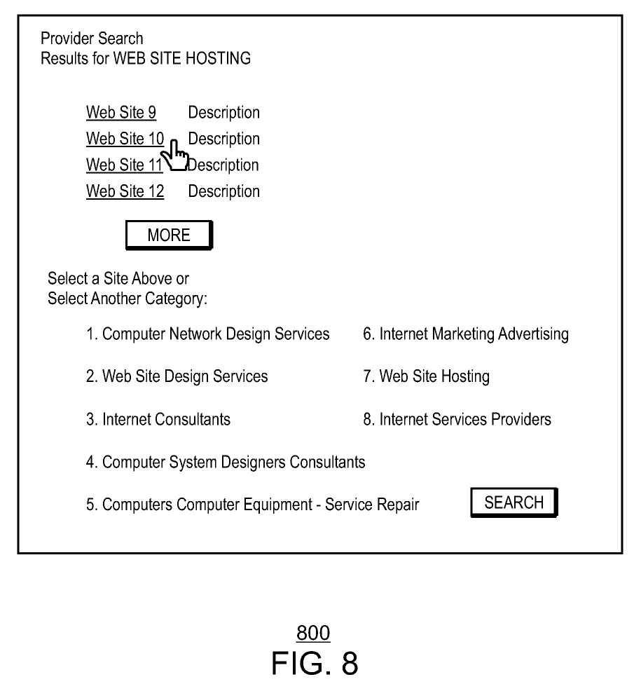

In this embodiment, the list of related category headings is generally illustrated at the bottom of the page. If the category headings are selected, the client could then click on the search button to obtain a new results screen. In this example, if the client clicks on “internet marketing advertising,” and then clicks the search button, the results screen shown in FIG. 7 could be provided by the guided search engine. As a final example, if the client selects the category heading “web site hosting,” and clicks on the search button, the results screen illustrated in FIG. 8 could be provided by the guided search engine. The guided search engine is not limited to providing results in the format shown above. Indeed, any format that effectively provides the results and options may be used, and is within the scope of the present invention. For example, the guided search engine could provide a first screen with results and a second screen with refined category headings, which could be selected from the first screen by a link.

What is claimed is:

1. A method of identifying providers, comprising:
obtaining a keyword from a client;
obtaining a results document from a search, wherein the results document comprises references to documents that contain the keyword;
analyzing the results document to identify a plurality of the references;
accessing the documents corresponding to the identified references;
analyzing the accessed documents to determine a list of keywords; and
comparing the list of keywords to a list of keywords associated with each of a plurality of category headings to identify a list of related category headings.

2. The method of claim 1, comprising:
displaying the list of related category headings; and
displaying a list of providers for at least one of the related category headings.

3. The method of claim 1, wherein the documents comprise Web pages.

4. The method of claim 1, wherein the references comprise links to Web pages.

5. The method of claim 1, wherein each of the category headings is associated with a list of Web sites within a business directory.

6. The method of claim 1, wherein obtaining the results document comprises:
submitting the keyword to a search engine;
obtaining a Web page from the search engine comprising the references; and
storing a source code for the Web page from the search engine as the results document.

7. The method of claim 6, wherein analyzing the results document comprises:
identifying the references in the results document based at least in part on format and content; and
storing each of the references in a table entry.

8. The method of claim 1, wherein accessing the documents comprises:
forming command strings with the identified references;
issuing the command strings to retrieve the documents; and
storing a source code for each of the retrieved documents in a local memory for analysis.

9. The method of claim 8, comprising:
analyzing the source code for references to subpages;
accessing the subpages that are within the same domain; and
storing the source code for the subpages in a local memory for analysis.

10. The method of claim 1, wherein analyzing the accessed documents comprises:
counting an occurrence of words in the accessed documents; and
building a list of the words associated with a frequency of occurrence in the accessed documents.

11. The method of claim 10, wherein the list omits words that are not related to content.

12. The method of claim 11, wherein the omitted words comprise “HTTP”, “the”, “a”, “tag”, or any combinations thereof.

13. The method of claim 1, comprising:
allowing the client to select a category heading from the list of related category headings;
building a new list of keywords related to the category heading;
comparing the new list of keywords to the list of keywords associated with each of the plurality of category headings to identify a new list of related category headings;
displaying a list of providers for at least one of the related category headings in the new list of related category headings; and
displaying the new list of related category headings.

14. The method of claim 13, wherein building a new list of keywords comprises:
submitting the category heading to a search engine;
analyzing the Web page returned from the search engine to identify references to other Web pages; and
analyzing the source code for the other Web pages to build the new list of keywords.

15. A guided search engine, comprising:
a server that is adapted to execute stored instructions;
a storage device that is adapted to store data, wherein the data comprises keyword lists associated with each of a plurality of category headings; and
a memory device that stores instructions that are executable by the processor, the instructions comprising:
a results analyzer configured to obtain source codes for Web pages in a source document;
a keyword generator configured to analyze the source codes to build a list of keywords; and
a keyword comparator to compare the list of keywords to the keyword lists associated with each of the plurality of category headings.

16. The guided search engine of claim 15, comprising a network interface adapted to operatively couple the guided search engine to the Web.

17. The system of claim 15, comprising a business directory, wherein the business directory comprises a list of Web sites organized by the plurality of category headings.

18. The guided search engine of claim 15, comprising a display routine configured to display a list of providers from a business directory that are associated with at least one of the plurality of category headings.

19. The system of claim 18, wherein the display routine is configured to display a list of related category headings.

20. A tangible, computer-readable medium, comprising:
code configured to accept keywords from a client, access a search site over a network interface, and obtain a results document;
code configured to analyze the results document to identify a plurality of links to Web pages, access the Web pages using the identified links, and store a source code for each of the accessed Web pages in a memory;
code configured to analyze the source code for the accessed Web pages to build a list of keywords; and
code configured to compare the keywords to a list of keywords associated with each of a plurality of category headings in a business directory to generate a list of related category headings.
